(19) United States
(12) Patent Application Publication
(10) Pub. No.: US 2012/0243516 A1
(43) Pub. Date: Sep. 27, 2012

(54) MOBILE COMMUNICATION METHOD, MOBILE STATION, AND RADIO BASE STATION

(75) Inventor: Hiroyuki Ishii, Yokohama-shi (JP)

(73) Assignee: NTT DOCOMO, INC., Tokyo (JP)

(21) Appl. No.: 13/505,481

(22) PCT Filed: Nov. 2, 2010
(86) PCT No.: PCT/JP2010/069507

§ 371 Date: Jun. 15, 2012

(30) Foreign Application Priority Data
Nov. 2, 2009 (JP) 2009-252487

(51) Int. Cl. H04W 72/04

(52) U.S. Cl. 370/336

(57) ABSTRACT

To reduce interference to another system and realize the coexistence with the other system by reducing the probability of False Alarm in multicarrier transmission. A mobile communication method according to the present invention, in which a mobile station UE transmits uplink data to a radio base station eNB using a plurality of carriers, includes a step A of instructing the mobile station UE to perform the transmission of uplink data using a plurality of downlink control signals including an information element for notifying the presence or absence of the transmission of uplink data using a plurality of carriers in a predetermined time frame, and a step B of deciding whether to perform the transmission of the uplink data using the plurality of carriers based on the information element included in the plurality of received downlink control signals.

### TECHNICAL FIELD

The present invention relates to a mobile communication technology field, and particularly, to a mobile communication method, a mobile station, and a radio base station in a mobile communication system using the next generation mobile communication technology.

### BACKGROUND ART

A communication scheme, which is the next generation of a WCDMA (Wideband Code Division Multiplexing Access) scheme, an HSDPA (High-Speed Downlink Packet Access) scheme, an HSUPA (High-Speed Uplink Packet Access) scheme and the like, that is, an LTE (Long Term Evolution) scheme, has been discussed in the 3GPP, which is a group aiming to standardize the WCDMA, and the specification work is under progress.

As a radio access scheme in the LTE scheme, an OFDMA (Orthogonal Frequency Division Multiplexing Access) scheme has been defined for a downlink, and an SC-FDMA (Single-Carrier Frequency Division Multiple Access) scheme has been defined for an uplink.

The OFDMA scheme is a multicarrier transmission scheme in which a frequency band is divided into a plurality of narrow frequency bands (sub-carriers), and data is loaded on each sub-carrier for transmission. According to the OFDMA scheme, sub-carriers are densely arranged on the frequency axis while being orthogonal to one another, so that high-rate transmission is achieved, resulting in the improvement of frequency use efficiency.

The SC-FDMA scheme is a single carrier transmission scheme in which a frequency band is divided for each terminal, and transmission is performed using different frequency bands among a plurality of mobile stations UEs (User Equipments). According to the SC-FDMA scheme, since it is possible to easily and efficiently reduce interference among the mobile stations UEs and suppress variation in transmission power, the SC-FDMA scheme is advantageous in terms of low power consumption of a mobile station UE, expansion of coverage and the like.

The LTE scheme corresponds to a system in which a plurality of mobile stations UEs share one or two or more physical channels in an uplink and a downlink, and perform communication.

The channel shared by the plurality of mobile stations UEs is generally called a “shared channel”, and in the LTE scheme, the channel is “Physical Uplink Shared Channel (PUSCH)” in an uplink, and is “Physical Downlink Shared Channel (PDSCH)” in a downlink.

Furthermore, as a transport channel, the shared channel is UL-SCH (Uplink Shared Channel) in an uplink, and is DL-SCH (Downlink Shared Channel) in a downlink.

In a communication system using the above-mentioned shared channel, it is necessary to perform signaling to select a mobile station UE to which the shared channel is to be assigned in each sub-frame (1 ms in the LTE scheme), and to perform signaling to the effect that the shared channel is assigned to the selected mobile station UE.

In the LTE scheme, a control channel used for the signaling is called PDCCH (Physical Downlink Control Channel) or “DL L1/L2 Control Channel (Downlink L1/L2 Control Channel)”.

In addition, the above-mentioned process for selecting the mobile station UE to which the shared channel is to be assigned in each sub-frame is generally called “scheduling”. Furthermore, expression indicating the “assignment of the above-mentioned shared channel” may be expressed as the “assignment of a radio resource for the shared channel”.

Information on the physical downlink control channel, for example, includes “Downlink Scheduling Information” or “Uplink Scheduling Grant”.

The “Downlink Scheduling Information”, for example, includes assignment information of a downlink resource block related to a downlink shared channel, UE-ID, the number of streams, information on a precoding vector, a data size, a modulation scheme, and information on HARQ (hybrid automatic repeat request).

Furthermore, the “Uplink Scheduling Grant”, for example, includes assignment information of an uplink resource block related to an uplink shared channel, UE-ID, a data size, a modulation scheme, uplink transmission power information, and information on a demodulation reference signal in Uplink MIMO.

In addition, the above-mentioned “Downlink Scheduling Information” or “Uplink Scheduling Grant” may also be collectively called “DCI (Downlink Control Information)”.

In addition, by means of “UE-ID (RNTI)” in the uplink scheduling grant or the downlink scheduling information, a mobile station UE performs identification regarding whether the above-mentioned uplink scheduling grant or downlink scheduling information is transmitted to the mobile station UE itself.

More specifically, CRC bits included in the uplink scheduling grant or the downlink scheduling information have been masked by RNTI of the mobile station UE which is a transmission destination.

When a result of the CRC check performed by the mobile station UE using the CRC bits is OK, the mobile station UE determines that the uplink scheduling grant or the downlink scheduling information is transmitted to the mobile station UE itself. When the result of the CRC check is NG, the mobile station UE determines that the uplink scheduling grant or the downlink scheduling information has not been transmitted to the mobile station UE itself.

In addition, the CRC bits are used for determining whether a transmitted signal is erroneously decoded or correctly decoded.

Therefore, in the case in which a mobile station UE has received a signal in which CRC bits have been masked by RNTI of another mobile station UE, even when the signal is received without an error, a CRC check result is actually NG.

Furthermore, the number of the CRC bits and bits of the RNTI, for example, is 16.

In addition, generally, a mobile station UE, for example, attempts to decode 40 uplink scheduling grants or downlink scheduling information in one sub-frame. In this case, for example, the about 40 uplink scheduling grants or downlink scheduling information includes a signal actually transmitted to the mobile station UE itself, a signal transmitted to another mobile station UE, and a signal including only noise in the state in which no signal is transmitted.

Here, since the number of the CRC bits and bits of the RNTI is 16, False Alarm occurs with a probability of 1/2¹⁶.

Therefore, in the case of decoding the 40 uplink scheduling grants or the downlink scheduling information, the probability that the False Alarm occurs is 1/2¹⁶×40.

Here, the False Alarm indicates an event that the mobile station UE determines that an uplink scheduling grant or downlink scheduling information is transmitted to the mobile station UE itself, regardless of the fact that a radio base station eNB has not transmitted the uplink scheduling grant or the downlink scheduling information to the mobile station UE.

Furthermore, as a next-generation communication scheme of the LTE scheme, an LTE-advanced scheme is discussed in the 3GPP. Requirements of the LTE-advanced scheme have been summarized in Non-Patent Document 2.

In the LTE-advanced scheme, performing “Carrier aggregation” is agreed as the requirements. Here, the “Carrier aggregation” represents that communication is simultaneously performed using a plurality of carriers.

For example, when the “Carrier aggregation” is performed in the uplink, since the mobile station UE performs transmission using different carriers for each “Component Carrier”, the mobile station UE transmits an uplink signal using a plurality of carriers. Furthermore, even in one “Component Carrier”, performing multicarrier transmission is discussed.

However, a cellular phone system, a radio astronomy system, a satellite communication system, an air and sea radar system, an earth resources survey system, and a wireless LAN system, which are systems using a radio wave, generally separate frequency bands to be used in order to prevent mutual interference. Furthermore, for example, among frequency bands assigned for a cellular phone system, frequency bands assigned for a plurality of systems exist, and frequency bands of each system are separated from each other.

That is, a system using a radio wave separates frequency bands to be used, thereby preventing inter-system interference.

However, since a transmitter radiating a radio wave radiates an unnecessary wave (hereinafter, referred to as adjacent channel interference) in a band outside a frequency band of an own system, even when a frequency band is separated, mutual interference occurs among a plurality of adjacent systems. Therefore, when a power level of the unnecessary wave is high, it has a significant adverse influence on adjacent systems.

In order to prevent the adverse influence on the adjacent systems due to such adjacent channel interference, performance related to characteristics related to the above-mentioned adjacent channel interference and spurious radiation is defined in each system.

However, the above-mentioned conventional mobile communication system has the following problems.

As described above, in the LTE-advanced scheme, the “Carrier aggregation” is performed. However, when an uplink signal is transmitted using a plurality of carriers in an uplink, “Intermodulation products (hereinafter, referred to as “IM products”)” occur and cause interference to another system.

Hereinafter, with reference to FIG. 14 and FIG. 15, a description will be provided for an example in which the “IM products” cause interference to another system.

In FIG. 14 and FIG. 15, it is assumed that a bandwidth of one transmission carrier is “180 kHz”. Furthermore, it is assumed that a system band of an own system is “1920 MHz” to “1980 MHz”, and it is assumed that a system band of an interfered system (another system) is “1880 MHz” to “1890 MHz”.

In the case of FIG. 14, since single carrier transmission is performed in an own system, the “IM products” do not occur.

Furthermore, it is generally said that interference to an adjacent channel occurs in an area 2.5 times as large as a transmission bandwidth, and when the transmission bandwidth is “180 kHz”, interference occurs at a part of 360 kHz of both sides of a transmission band.

This means that there is no problem in terms of interference when considering that “1930 MHz” (a frequency of a transmission signal) is far away from “1880 MHz” to “1890 MHz” which is the system band of the interfered system (another system).

Meanwhile, in the case of FIG. 15, since multicarrier transmission is performed in an own system, “IM products” caused by a first transmission carrier and a second transmission carrier occur at a frequency of “1890 MHz”.

This is interference which is not permissible to the interfered system (another system) having a system band of “1880 MHz” to “1890 MHz”.

Here, generally, since a radio base station eNB designates uplink transmission to a mobile station UE by the uplink scheduling grant as described above, even when the above-mentioned multicarrier transmission is performed, it is possible to control a transmission timing or a transmission frequency thereof.

Furthermore, it is difficult for the radio base station eNB to perfectly control uplink transmission power, but it is possible to perceive the amplitude of the transmission power of an uplink signal which is transmitted.

Thus, it is possible for the radio base station eNB to predict the occurrence of the above-mentioned “IM products”, resulting in the avoidance of interference due to the “IM products”.

However, when the False Alarm of the above-mentioned uplink scheduling grant has occurred, since the mobile station UE transmits an uplink signal regardless of the control of the radio base station eNB, it is not possible to predict the occurrence of the above-mentioned “IM products”, resulting in the non-avoidance of the interference due to the “IM products”.

### SUMMARY OF THE INVENTION

Therefore, the present invention is achieved in view of the above-described problems, and an object thereof is to provide a mobile communication method, a mobile station, and a radio base station, by which it is possible to reduce interference to another system and realize the coexistence with the other system by reducing the probability of False Alarm in multicarrier transmission.

A first characteristic of the present embodiment is summarized in that a mobile communication method, in which a mobile station transmits uplink data to a radio base station using a plurality of carriers, comprising, a step A of instructing the mobile station to perform transmission of uplink data using a plurality of downlink control signals including an information element for notifying presence or absence of transmission of the uplink data using a plurality of carriers in a predetermined time frame, and a step B of deciding whether to perform the transmission of the uplink data using the plurality of carriers based on the information element included in the plurality of received downlink control signals.

A second characteristic of the present embodiment is summarized in that a mobile station, which is configured to transmit uplink data to a radio base station using a plurality of carriers, comprising, a control signal reception unit configured to receive a plurality of downlink control signals from the radio base station, the plurality of downlink control signals including an information element for notifying presence or absence of transmission of uplink data using a plurality of carriers in a predetermined time frame, and a transmission unit configured to decide whether to perform the transmission of the uplink data using the plurality of carriers based on the information element included in the plurality of received downlink control signals.

A third characteristic of the present embodiment is summarized in that a radio base station, which is configured to receive uplink data from a mobile station using a plurality of carriers, comprising, a control signal transmission unit configured to transmit a plurality of downlink control signals to the mobile station, the plurality of downlink control signals including an information element for notifying presence or absence of transmission of uplink data using a plurality of carriers in a predetermined time frame and instructing the transmission of the uplink data using the plurality of carriers, and a reception unit configured to receive the uplink data transmitted by the mobile station using the plurality of carriers based on the plurality of downlink control signals.

A fourth characteristic of the present embodiment is summarized in that a mobile communication method, in which a radio base station transmits downlink data to a mobile station using a plurality of carriers, comprising, a step A of instructing the mobile station to perform reception of downlink data using a plurality of downlink control signals including an information element for notifying presence or absence of transmission of downlink data using a plurality of carriers in a predetermined time frame, and a step B of deciding whether to perform the reception of the downlink data using the plurality of carriers based on the information element included in the plurality of received downlink control signals.

A fifth characteristic of the present embodiment is summarized in that a mobile station, which is configured to receive downlink data from a radio base station using a plurality of carriers, comprising, a control signal reception unit configured to receive a plurality of downlink control signals from the radio base station, the plurality of downlink control signals including an information element for notifying presence or absence of transmission of downlink data using a plurality of carriers in a predetermined time frame, and a reception unit configured to decide whether to perform the reception of the downlink data using the plurality of carriers based on the information element included in the plurality of received downlink control signals.

A sixth characteristic of the present embodiment is summarized in that a radio base station, which is configured to transmit downlink data to a mobile station using a plurality of carriers, comprising, a control signal transmission unit configured to transmit a plurality of downlink control signals to the mobile station, the plurality of downlink control signals including an information element for notifying presence or absence of transmission of downlink data using a plurality of carriers in a predetermined time frame and instructing reception of the downlink data using the plurality of carriers, and a transmission unit configured to transmit the downlink data to the mobile station using the plurality of carriers designated by the plurality of downlink control signals.

### BRIEF DESCRIPTION OF THE DRAWINGS

FIG. 1 is a diagram showing the entire configuration of a mobile communication system according to a first embodiment of the present invention.

FIG. 2 is a functional block diagram of a mobile station UE according to the first embodiment of the present invention.

FIG. 3 is a diagram explaining “Carrier aggregation” in the mobile station UE according to the first embodiment of the present invention.

FIG. 4 is a diagram explaining “Carrier aggregation” in the mobile station UE according to the first embodiment of the present invention.

FIG. 5 is a diagram explaining “Carrier aggregation” in the mobile station UE according to the first embodiment of the present invention.

FIG. 6 is a diagram explaining “Carrier aggregation” in the mobile station UE according to the first embodiment of the present invention.

FIG. 7 is a diagram explaining “Carrier aggregation” in the mobile station UE according to the first embodiment of the present invention.

FIG. 8 is a diagram explaining “Carrier aggregation” in the mobile station UE according to the first embodiment of the present invention.

FIG. 9 is a diagram explaining “Carrier aggregation” in the mobile station UE according to the first embodiment of the present invention.

FIG. 10 is a diagram explaining “Carrier aggregation” in the mobile station UE according to the first embodiment of the present invention.

FIG. 11 is a diagram explaining “Carrier aggregation” in the mobile station UE according to the first embodiment of the present invention.

FIG. 12 is a diagram explaining “Carrier aggregation” in the mobile station UE according to the first embodiment of the present invention.

FIG. 13 is a functional block diagram of a radio base station eNB according to the first embodiment of the present invention.

FIG. 14 is a diagram explaining a conventional mobile communication system.

FIG. 15 is a diagram explaining a conventional mobile communication system.

### DETAILED DESCRIPTION

(Mobile Communication System According to First Embodiment of the Present Invention)

Hereinafter, a mobile communication system according to a first embodiment of the present invention will be described with reference to the accompanying drawings. Throughout all the drawings for explaining the present embodiment, elements having the same function will be designated by the same reference numerals, and repetitive explanation thereof will be omitted.

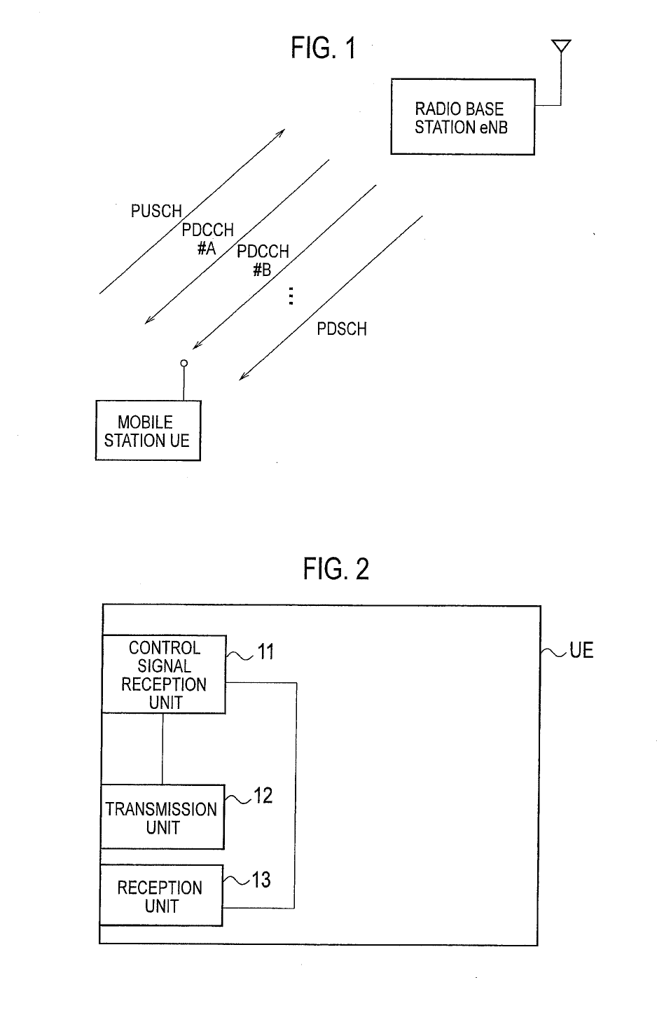

With reference to FIG. 1, the mobile communication system including a mobile station UE and a radio base station eNB according to the present embodiment will be described.

The mobile communication system according to the present embodiment, for example, is a system employing an “Evolved UTRA and UTRAN (another name: Long Term Evolution or Supper 3G)” scheme or an LTE-Advanced scheme.

As illustrated in FIG. 1, the mobile communication system according to the present embodiment includes the radio base station eNB and the mobile station UE communicating with the radio base station eNB.

In the mobile communication system according to the present embodiment, as a radio access scheme, an “OFDMA (Orthogonal Frequency Division Multiplexing Access) scheme” is applied to a downlink, and an “SC-FDMA (Single-Carrier Frequency Division Multiple Access) scheme” is applied to an uplink.

As described above, the OFDMA scheme is a multicarrier transmission scheme in which a frequency band is divided into a plurality of narrow frequency bands (sub-carriers) and data is mapped to each sub-carrier, so that communication is performed. Furthermore, the SC-FDMA scheme is a single carrier transmission scheme in which a frequency band is divided for each mobile station UE, and a plurality of mobile stations UEs use frequency bands different from one another, so that interference among the mobile stations UEs is reduced.

In addition, in the mobile communication system according to the present embodiment, “Carrier Aggregation” is configured to be performed.

Specifically, for a downlink, communication using a plurality of “Component Carriers” is performed. Here, the “Component Carrier” corresponds to one system carrier in an LTE scheme. That is, in the LTE scheme, communication is performed using one “Component Carrier”, but in an LTE-Advanced scheme, communication may be performed using two or more “Component Carriers”.

Even for an uplink, communication may be performed using two or more “Component Carriers”. Furthermore, in the LTE scheme, basically, single carrier transmission is performed, but in the LTE-Advanced scheme, multicarrier transmission may also be performed.

Here, multicarrier transmission may be multicarrier transmission over a plurality of “Component Carriers”, multicarrier transmission in one “Component Carrier”, or multicarrier transmission over a plurality of “Component Carriers” and multicarrier transmission in one “Component Carrier”.

Hereinafter, a communication channel used in the “Evolved UTRA and UTRAN (LTE)” scheme will be described. In addition, the following communication channel is also used in the LTE-Advanced scheme.

For a downlink, a “physical downlink shared channel (PDSCH)” and a “physical downlink control channel (PDCCH)” shared by each mobile station UE are used.

The “physical downlink shared channel (PDSCH)” is used to transmit user data, that is, a normal data signal.

Here, the data signal includes best effort type packet data, streaming type packet data, a control signal, and the like. The best effort type packet data includes packet data for transmitting/receiving an e-mail, packet data for Web browsing, and the like. Furthermore, the data signal may include a sound signal and the like by VoIP and the like.

Furthermore, the control signal, for example, corresponds to an RRC message, and may correspond to DCCH (Dedicated Control Channel) as a logical channel.

Furthermore, the PDCCH is used to notify information (that is, downlink scheduling information) on an ID of a mobile station UE performing communication using the PDSCH or a transport format of user data, information (that is, an uplink scheduling grant) on an ID of a mobile station UE performing communication using PUSCH (Physical Uplink Shared Channel) or a transport format of user data, and the like.

The PDCCH may also be called “Downlink L1/L2 Control Channel”. Furthermore, the “downlink scheduling information” or the “uplink scheduling grant” may also be collectively called “downlink control information (DCI)”.

Furthermore, in a downlink, “BCCH: Broadcast Control Channel” is transmitted as a logical channel.

A part of the BCCH is mapped to “BCH: Broadcast Channel” (a transport channel), and information mapped to the BCH is transmitted to a mobile station UE in a corresponding cell through “P-BCH: Physical Broadcast Channel” (a physical channel).

Furthermore, a part of the BCCH is mapped to “DL-SCH: Downlink Shared Channel” (a transport channel), and information mapped to the DL-SCH is transmitted to a mobile station UE in the corresponding cell through the “PDSCH” (a physical channel).

A broadcast channel transmitted through the BCCH/DL-SCH/PDSCH may also be called a dynamic broadcast channel (D-BCH).

For an uplink, the PUSCH and the PDCCH are shared and used by each mobile station UE are used. The PUSCH is used to transmit user data, that is, a normal data signal.

Furthermore, the PUCCH is used to transmit downlink quality information (CQI: Channel Quality Indicator), which is to be used in a scheduling process of the PDSCH or AMCS (Adaptive Modulation and Coding Scheme), and transmission acknowledgement information (Acknowledgement Information) of the PDSCH.

The downlink quality information may also be called CSI (Channel State Indicator) which is an indicator which groups together CQI, PMI (Pre-coding Matrix Indicator), or RI (Rank Indicator).

Furthermore, the content of the transmission acknowledgement information is expressed by any one of a positive response (ACK: Acknowledgement) indicating that a transmission signal is properly received, and a negative response (NACK: Negative Acknowledgement) indicating that the transmission signal has not been properly received.

In addition, when a transmission timing of the above-mentioned CQI or transmission acknowledgement information is equal to a transmission timing of the PUSCH, the CQI or the transmission acknowledgement information may also be multiplexed to the PUSCH for transmission.

As illustrated in FIG. 2, the mobile station UE includes a control signal reception unit 11, a transmission unit 12, and a reception unit 13.

The control signal reception unit 11 is configured to receive a plurality of downlink control signals for instructing the transmission of uplink data (specifically, uplink data to be transmitted through the PUSCH), or the reception of downlink data (specifically, downlink data to be transmitted through the PDSCH).

Specifically, the control signal reception unit 11 may be configured to receive an “uplink scheduling grant” or “downlink scheduling information” through the PDCCH as the downlink control signal.

In the case of an uplink, the downlink control signal may include at least one of a transmission bandwidth of uplink data, a modulation scheme of the uplink data, and a transmission frequency of the uplink data as a parameter.

Furthermore, in the case of a downlink, the downlink control signal may include at least one of information indicating a transmission band of downlink data and a modulation scheme of the downlink data as a parameter.

Furthermore, the downlink control signal may also include an information element for notifying the presence or absence of the transmission of uplink data using a plurality of carriers in a predetermined time frame (a sub-frame), or an information element for notifying the presence or absence of the transmission of downlink data using a plurality of carriers in a predetermined time frame (a sub-frame).

The transmission unit 12 is configured to transmit uplink data to the radio base station eNB based on the downlink control signal received in the control signal reception unit 11.

Here, the transmission unit 12 may be configured to decide whether to perform the transmission of the uplink data using the plurality of carriers, that is, to perform multicarrier transmission based on the information element included in the downlink control signal received in the control signal reception unit 11.

The information element may include one bit or a plurality of bits.

For example, when “1” is set to the information element, the information element may indicate that the transmission of the uplink data using the plurality of carriers exists. When “0” is set to the information element, the information element may indicate that the transmission of the uplink data using the plurality of carriers does not exist.

Furthermore, the information element may also include a bit indicating whether to perform the transmission of an uplink control signal (specifically, an uplink control signal through the PUCCH) using the plurality of carriers.

Here, only when an information element included in a plurality of downlink control signals indicates that the transmission of the uplink data using the plurality of carriers exists, the transmission unit 12 may also be configured to decide to perform the transmission of the uplink data using the plurality of carriers based on the plurality of downlink control signals.

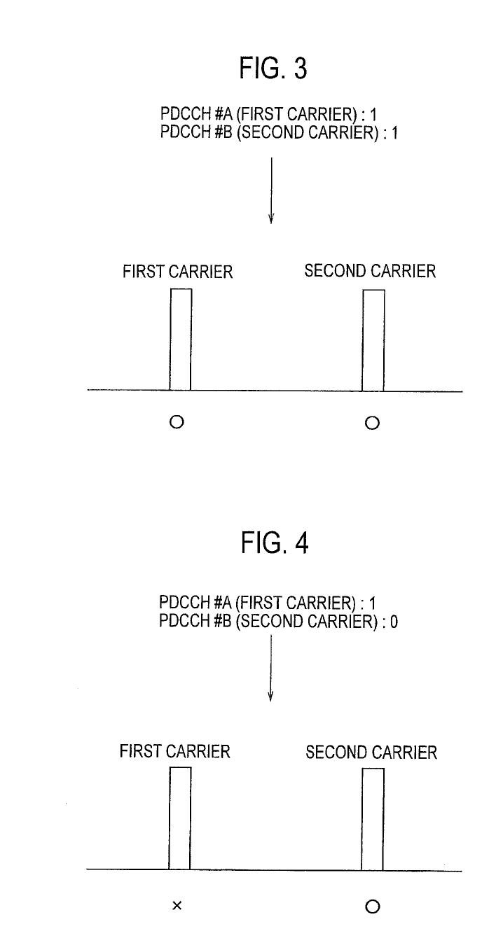

For example, as illustrated in FIG. 3, only when “1” is set to both information elements included in a plurality of downlink control signals, that is, downlink control signals transmitted through PDCCH #A and PDCCH #B, the transmission unit 12 may also be configured to decide to perform the transmission (multicarrier transmission) of uplink data using a plurality of carriers, that is, a first carrier and a second carrier, based on the downlink control signals transmitted through the PDCCH #A and the PDCCH #B.

Here, it is assumed that the downlink control signal transmitted through the PDCCH #A instructs the transmission of an uplink signal using the first carrier, and the downlink control signal transmitted through the PDCCH #B instructs the transmission of an uplink signal using the second carrier.

Here, the information element in the downlink control signal transmitted through the PDCCH #A notifies whether the transmission of the uplink signal using the second carrier exists, and the information element in the downlink control signal transmitted through the PDCCH #B notifies whether the transmission of the uplink signal using the first carrier exists.

Furthermore, when an information element included in one of the plurality of downlink control signals indicates that the transmission of the uplink data using the plurality of carriers does not exist, the transmission unit 12 may also be configured to decide to perform the transmission of the uplink data based on a downlink control signal including the information element indicating that the transmission of the uplink data using the plurality of carriers does not exist.

For example, as illustrated in FIG. 4, when “0” and “1” have been set to information elements included in one of the plurality of downlink control signals, that is, “0” is set to the information element included in the downlink control signal transmitted through the PDCCH #B and “1” is set to the information element included in the downlink control signal transmitted through the PDCCH #A, the transmission unit 12 may also be configured to decide to perform the transmission (single carrier transmission) of the uplink data using the second carrier based on the downlink control signal transmitted through the PDCCH #B.

In the case of FIG. 4, since a contradiction exists between the information element in the PDCCH #A and the information element in the PDCCH #B, it is assumed that one of the PDCCHs corresponds to False Alarm.

In the case of FIG. 4, based on the assumption that appropriate setting is performed for an information element in PDCCH not corresponding to the False Alarm, it is assumed that the PDCCH #B for transmitting the information element having “0” set thereto is a properly received PDCCH, and the PDCCH #A for transmitting the information element having “1” set thereto corresponds to the False Alarm.

For the above reason, the transmission unit 12 may also be configured to decide to perform the transmission (the single carrier transmission) of the uplink data using the second carrier based on the downlink control signal transmitted through the PDCCH #B.

Furthermore, when an information element included in one of the plurality of downlink control signals indicates that the transmission of the uplink data using the plurality of carriers does not exist, the transmission unit 12 may also be configured to decide not to perform the transmission of the uplink data in relation to all the plurality of the downlink control signals.

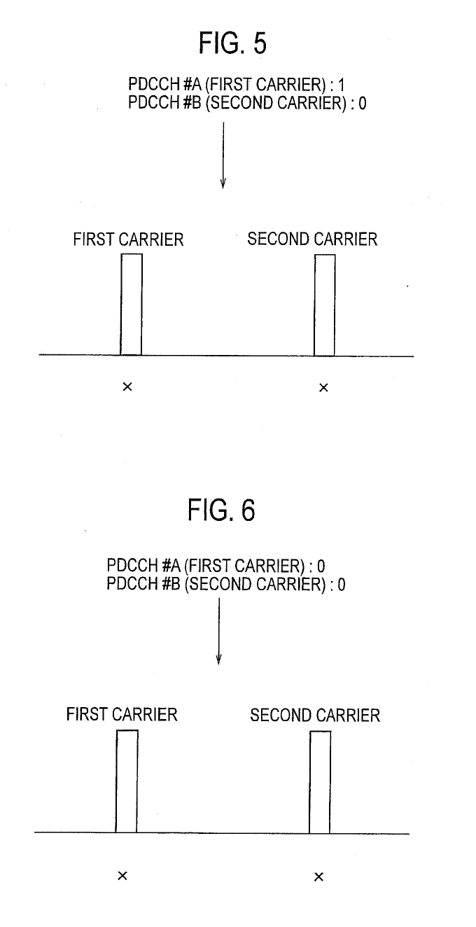

For example, as illustrated in FIG. 5, when information elements included in one of the plurality of downlink control signals, that is, “0” is set to the information element included in the downlink control signal transmitted through the PDCCH #B and “1” is set to the information element included in the downlink control signal transmitted through the PDCCH #A, the transmission unit 12 may also be configured to decide not to perform the transmission (multicarrier transmission) of the uplink data using the first carrier and the second carrier in relation to the both downlink control signals transmitted through the PDCCH #A and the PDCCH #B.

In the case of FIG. 5, since a contradiction exists between the information element in the PDCCH #A and the information element in the PDCCH #B, it is assumed that one of the PDCCHs corresponds to the False Alarm.

In the case of FIG. 5, based on the belief that PDCCH corresponding to the False Alarm is not clear, the transmission unit 12 may also be configured to decide neither to perform the transmission of an uplink data signal based on the downlink control signal transmitted through the PDCCH #B, nor the transmission of an uplink data signal based on the downlink control signal transmitted through the PDCCH #A.

In the case of FIG. 5, as a consequence, it is possible to perform the transmission of an uplink data signal more reliably according to an instruction of the radio base station eNB, as compared with the operation in the case of FIG. 4.

In addition, as illustrated in FIG. 6, when information elements included in one of the plurality of downlink control signals, that is, “0” is set to the information element included in the downlink control signal transmitted through the PDCCH #B and “0” is set to the information element included in the downlink control signal transmitted through the PDCCH #A, the transmission unit 12 may also be configured to decide not to perform the transmission of the uplink data using the first carrier and the second carrier in relation to the both downlink control signals transmitted through the PDCCH #A and the PDCCH #B.

In the case of FIG. 6, since a contradiction exists between the information element in the PDCCH #A and the information element in the PDCCH #B, it is assumed that one of the PDCCHs corresponds to the False Alarm.

Furthermore, in the case of FIG. 6, it is assumed that it is difficult to determine PDCCH corresponding to the False Alarm, differently from the case of FIG. 4.

In the case of FIG. 6, based on the belief that PDCCH corresponding to the False Alarm is not clear, the transmission unit 12 may also be configured to decide neither to perform the transmission of an uplink data signal based on the downlink control signal transmitted through the PDCCH #B, nor the transmission of an uplink data signal based on the downlink control signal transmitted through the PDCCH #A.

In the case of FIG. 6, it is possible to perform the transmission of an uplink data signal more reliably according to an instruction of the radio base station eNB.

In addition, in the above-mentioned example, it is decided whether to perform the transmission of uplink data using a plurality of carriers, that is, perform the multicarrier transmission, based on the 1-bit information element indicating whether the multicarrier transmission is performed. Instead, bits indicating the presence or absence of the transmission of each carrier other than an own carrier may be defined, and it may be configured to decide whether to perform the transmission of the uplink data using the plurality of carriers, that is, perform the multicarrier transmission, based on the bits.

In this case, when no contradiction exists between the bits indicating the presence or absence of the transmission of each carrier other than the own carrier, the transmission unit 12 may also be configured to decide to perform the transmission of the uplink data based on the downlink control signal.

In other words, when a contradiction exists between the bits indicating the presence or absence of the transmission of each carrier other than the own carrier, the transmission unit 12 may also be configured to decide not to perform the transmission of the uplink data based on the downlink control signal.

For example, the following is an example of the case in which the first carrier and the second carrier exist.

Here, it is assumed that the downlink control signal transmitted through the PDCCH #A instructs the transmission of an uplink signal using the first carrier, and the downlink control signal transmitted through the PDCCH #B instructs the transmission of an uplink signal using the second carrier.

Furthermore, it is assumed that a bit indicating the transmission of the second carrier is defined in the PDCCH #A and a bit indicating the transmission of the first carrier is defined in the PDCCH #B.

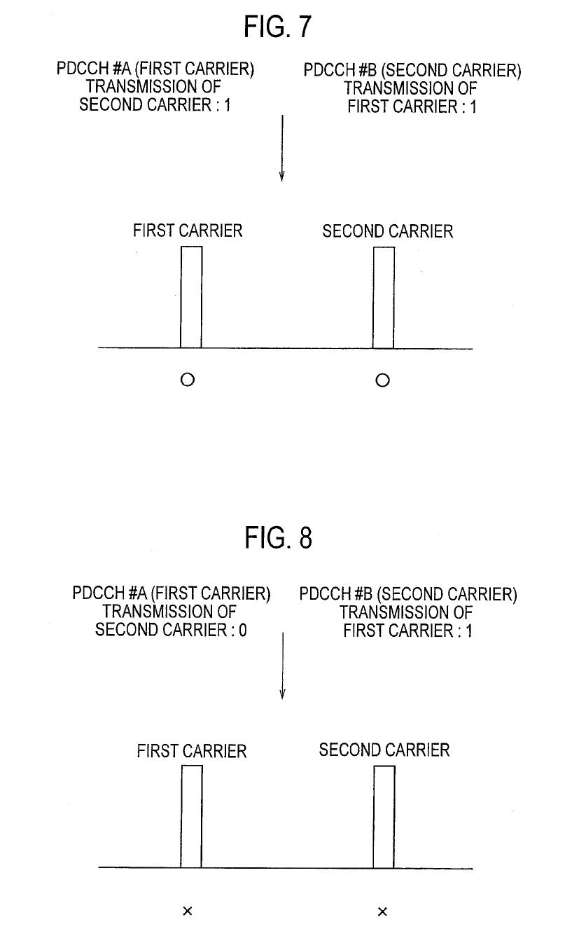

Here, when the bit is “1”, it means that the transmission of a corresponding carrier is performed. When the bit is “0”, it means that the transmission of the corresponding carrier is not performed. For example, as illustrated in FIG. 7, a case may be considered: in the information element included in a plurality of downlink control signals, i.e., the downlink control signal transmitted through the PDCCH #A, “1” is set in relation to the transmission of the second carrier, and in the information element included in the downlink control signal transmitted through the PDCCH #B, “1” is set in relation to the transmission of the first carrier.

In the case of FIG. 7, since no contradiction exists between the information element included in the downlink control signal transmitted through the PDCCH #A and the information element included in the downlink control signal transmitted through the PDCCH #B, the transmission unit 12 may also be configured to decide to perform the transmission (multicarrier transmission) of the uplink data using the plurality of carriers, that is, the first carrier and the second carrier, based on the downlink control signals transmitted through the PDCCH #A and the PDCCH #B.

Furthermore, for example, as illustrated in FIG. 8, a case may be considered: in the information element included in a plurality of downlink control signals, i.e., the downlink control signal transmitted through the PDCCH #A, “0” is set in relation to the transmission of the second carrier, and in the information element included in the downlink control signal transmitted through the PDCCH #B, “1” is set in relation to the transmission of the first carrier.

In the case of FIG. 8, since a contradiction exists between the information element included in the downlink control signal transmitted through the PDCCH #A and the information element included in the downlink control signal transmitted through the PDCCH #B, the transmission unit 12 may also be configured to decide neither to perform the transmission of an uplink data signal of the second carrier based on the downlink control signal transmitted through the PDCCH #B, nor the transmission of an uplink data signal of the first carrier based on the downlink control signal transmitted through the PDCCH #A.

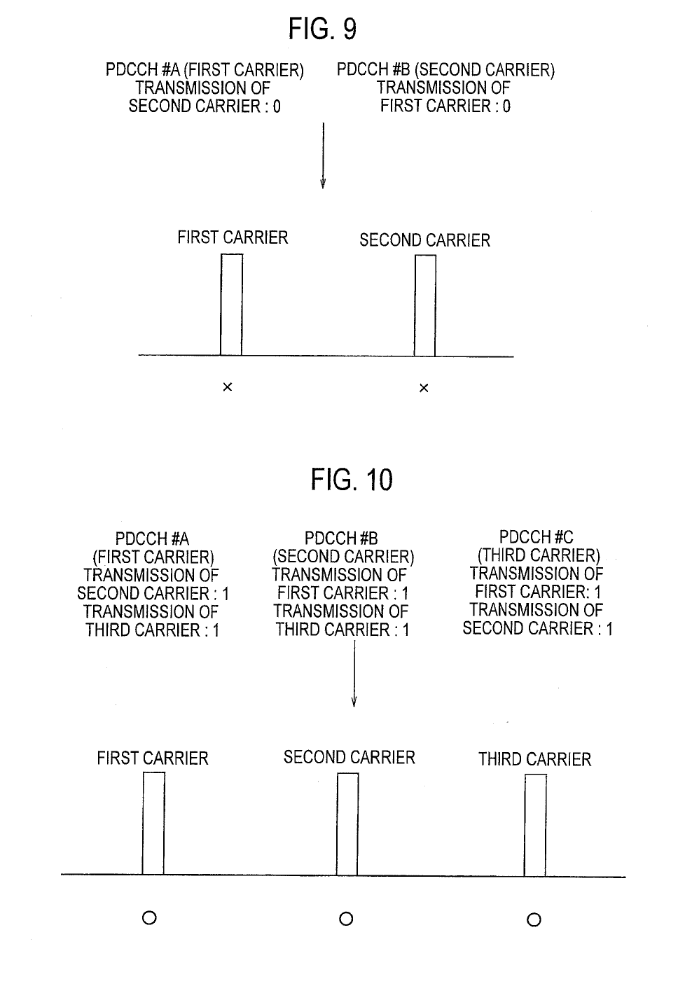

Furthermore, for example, as illustrated in FIG. 9, a case may be considered: in the information element included in a plurality of downlink control signals, i.e., the downlink control signal transmitted through the PDCCH #A, “0” is set in relation to the transmission of the second carrier, and in the information element included in the downlink control signal transmitted through the PDCCH #B, “0” is set in relation to the transmission of the first carrier.

In the case of FIG. 9, since a contradiction exists between the information element included in the downlink control signal transmitted through the PDCCH #A and the information element included in the downlink control signal transmitted through the PDCCH #B, the transmission unit 12 may also be configured to decide neither to perform the transmission of an uplink data signal of the second carrier based on the downlink control signal transmitted through the PDCCH #B, nor the transmission of an uplink data signal of the first carrier based on the downlink control signal transmitted through the PDCCH #A.

Next, the following is an example of the case in which the first carrier, the second carrier, and a third carrier exist.

Here, it is assumed that the downlink control signal transmitted through the PDCCH #A instructs the transmission of an uplink signal using the first carrier, the downlink control signal transmitted through the PDCCH #B instructs the transmission of an uplink signal using the second carrier, and a downlink control signal transmitted through PDCCH #C instructs the transmission of an uplink signal using the third carrier.

Furthermore, it is assumed that a bit indicating the transmission of the second carrier and a bit indicating the transmission of the third carrier have been defined in the PDCCH #A, a bit indicating the transmission of the first carrier and the bit indicating the transmission of the third carrier have been defined in the PDCCH #B, and the bit indicating the transmission of the first carrier and the bit indicating the transmission of the second carrier have been defined in the PDCCH #C.

Here, when the bit is “1”, it means that the transmission of a corresponding carrier is performed. When the bit is “0”, it means that the transmission of the corresponding carrier is not performed.

For example, as illustrated in FIG. 10, a case may be considered: in the information element included in a plurality of downlink control signals, i.e., the downlink control signal transmitted through the PDCCH #A, “1” is set in relation to the transmission of the second carrier and “1” is set in relation to the transmission of the third carrier, in the information element included in the downlink control signal transmitted through the PDCCH #B, “1” is set in relation to the transmission of the first carrier and “1” is set in relation to the transmission of the third carrier, and in the information element included in the downlink control signal transmitted through the PDCCH #C, “1” is set in relation to the transmission of the first carrier and “1” is set in relation to the transmission of the second carrier.

In the case of FIG. 10, since no contradiction exists among the information element included in the downlink control signal transmitted through the PDCCH #A, the information element included in the downlink control signal transmitted through the PDCCH #B, and the information element included in the downlink control signal transmitted through the PDCCH #C, the transmission unit 12 may also be configured to decide to perform the transmission (multicarrier transmission) of the uplink data using the plurality of carriers, that is, the first carrier, the second carrier, and the third carrier, based on the downlink control signals transmitted through the PDCCH #A, the PDCCH #B, and the PDCCH #C.

Here, for example, when “0” is set with respect to at least one of the PDCCH #A, the PDCCH #B, and the PDCCH #C in relation to carriers other than an own carrier, since a contradiction exists thereamong, the transmission unit 12 may also be configured to decide not to perform the transmission (multicarrier transmission) of the uplink data in relation to all of the first carrier, the second carrier, and the third carrier.

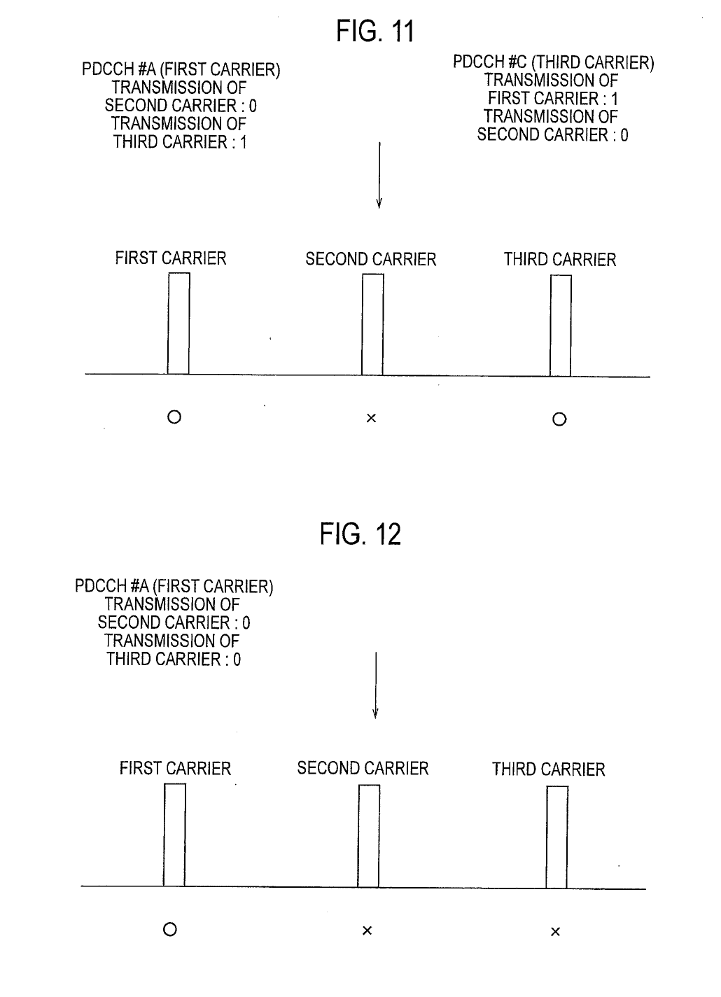

For example, as illustrated in FIG. 11, a case may be considered: in the information element included in a plurality of downlink control signals, i.e., the downlink control signal transmitted through the PDCCH #A, “0” is set in relation to the transmission of the second carrier and “1” is set in relation to the transmission of the third carrier, the PDCCH #B does not exist, in the information element included in the downlink control signal transmitted through the PDCCH #C, “1” is set in relation to the transmission of the first carrier and “0” is set in relation to the transmission of the second carrier.

In the case of FIG. 11, since no contradiction exists among the information element included in the downlink control signal transmitted through the PDCCH #A, the absence of the PDCCH #B, and the information element included in the downlink control signal transmitted through the PDCCH #C, the transmission unit 12 may also be configured to decide to perform the transmission (multicarrier transmission) of the uplink data using the plurality of carriers, that is, the first carrier and the third carrier, based on the downlink control signals transmitted through the PDCCH #A and the PDCCH #C.

Here, for example, when the information elements in the PDCCH #A and the PDCCH #C have the values of FIG. 11 and the PDCCH #B exists, since a contradiction exists thereamong, the transmission unit 12 may also be configured to decide not to perform the transmission (multicarrier transmission) of the uplink data in relation to all of the first carrier, the second carrier, and the third carrier.

Alternatively, for example, when a contradiction exists between an information element related to the presence or absence of the transmission of the third carrier in the PDCCH #A and an information element related to the presence or absence of the transmission of the first carrier in the PDCCH #C, the transmission unit 12 may also be configured to decide not to perform the transmission (multicarrier transmission) of the uplink data in relation to all of the first carrier, the second carrier, and the third carrier.

For example, as illustrated in FIG. 12, a case may be considered: in the information element included in a plurality of downlink control signals, i.e., the downlink control signal transmitted through the PDCCH #A, “0” is set in relation to the transmission of the second carrier, “0” is set in relation to the transmission of the third carrier, and the PDCCH #B and the PDCCH #C do not exist. In this case, since no contradiction exists between the information element included in the downlink control signal transmitted through the PDCCH #A and the absence of the PDCCH #B and the PDCCH #C, the transmission unit 12 may also be configured to decide to perform the transmission (single carrier transmission) of the uplink data using the single carrier, that is, the first carrier, based on the downlink control signal transmitted through the PDCCH #A.

Here, for example, when the information element in the PDCCH #A has the value of FIG. 12 and the PDCCH #B or the PDCCH #C exists, since a contradiction exists therebetween, the transmission unit 12 may also be configured to decide not to perform the transmission (multicarrier transmission) of the uplink data in relation to all of the first carrier, the second carrier, and the third carrier.

In addition, in the above-mentioned example, in relation to carriers other than an own carrier, bits indicating the presence or absence of the transmission of the carriers have been defined. Instead, in relation to carriers including the own carrier, bits indicating the presence or absence of the transmission of the carriers may be defined.

In this case, in addition to the above-mentioned determination, when a bit indicating the presence or absence of the transmission of the own carrier is “0”, it may be determined that a contradiction exists. When the bit indicating the presence or absence of the transmission of the own carrier is “1”, it may be determined that no contradiction exists.

The reception unit 13 is configured to receive downlink data from the radio base station eNB based on the downlink control signal received in the control signal reception unit 11.

Here, the reception unit 13 may be configured to decide to perform the reception of the downlink data using the plurality of carriers, that is, decide whether to perform multicarrier transmission, based on an information element included in the downlink control signal received in the control signal reception unit 11.

Specifically, only when an information element included in a plurality of downlink control signals indicates that the transmission of the downlink data using the plurality of carriers exists, the reception unit 13 may also be configured to decide to perform the reception of the downlink data using the plurality of carriers based on the plurality of downlink control signals.

For example, as illustrated in FIG. 3, only when “1” is set to the both information elements included in a plurality of downlink control signals, i.e., the downlink control signals transmitted through the PDCCH #A and the PDCCH #B, the reception unit 13 may also be configured to decide to perform the reception (multicarrier reception) of downlink data using the plurality of carriers, that is, the first carrier and the second carrier, based on the downlink control signals transmitted through the PDCCH #A and the PDCCH #B.

Here, it is assumed that the downlink control signal transmitted through the PDCCH #A instructs the reception of a downlink signal using the first carrier, and the downlink control signal transmitted through the PDCCH #B instructs the reception of a downlink signal using the second carrier.

Here, the information element in the downlink control signal transmitted through the PDCCH #A notifies whether the transmission of the downlink signal using the second carrier exists, and the information element in the downlink control signal transmitted through the PDCCH #B notifies whether the transmission of the downlink signal using the first carrier exists.

Furthermore, when an information element included in one of the plurality of downlink control signals indicates that the transmission of the downlink data using the plurality of carriers does not exist, the reception unit 13 may also be configured to decide to perform the reception of the downlink data based on a downlink control signal including the information element indicating that the transmission of the downlink data using the plurality of carriers does not exist.

For example, as illustrated in FIG. 4, when “0” and “1” have been set to information elements included in one of the plurality of downlink control signals, that is, “0” is set to the information element included in the downlink control signal transmitted through the PDCCH #B and “1” is set to the information element included in the downlink control signal transmitted through the PDCCH #A, the reception unit 13 may also be configured to decide to perform the reception (single carrier reception) of the downlink data using the second carrier based on the downlink control signal transmitted through the PDCCH #B.

In the case of FIG. 4, since a contradiction exists between the information element in the PDCCH #A and the information element in the PDCCH #B, it is assumed that one of the PDCCHs corresponds to False Alarm.

In the case of FIG. 4, based on the assumption that appropriate setting is performed for an information element in PDCCH not corresponding to the False Alarm, it is assumed that the PDCCH #B for transmitting the information element having “0” set thereto is a properly received PDCCH, and the PDCCH #A for transmitting the information element having “1” set thereto corresponds to the False Alarm.

For the above reason, the reception unit 13 may also be configured to decide to perform the reception (the single carrier reception) of the downlink data using the second carrier based on the downlink control signal transmitted through the PDCCH #B.

Furthermore, when an information element included in one of the plurality of downlink control signals indicates that the transmission of the downlink data using the plurality of carriers does not exist, the reception unit 13 may also be configured to decide not to perform the reception of the downlink data in relation to all the plurality of downlink control signals.

For example, as illustrated in FIG. 5, when “0” and “1” have been set to information elements included in one of the plurality of downlink control signals, that is, “0” is set to the information element included in the downlink control signal transmitted through the PDCCH #B and “1” is set to the information element included in the downlink control signal transmitted through the PDCCH #A, the reception unit 13 may be configured to decide not to perform the reception (multicarrier reception) of the downlink data using the first carrier and the second carrier in relation to the both downlink control signals transmitted through the PDCCH #A and the PDCCH #B.

In the case of FIG. 5, since a contradiction exists between the information element in the PDCCH #A and the information element in the PDCCH #B, it is assumed that one of the PDCCHs corresponds to the False Alarm.

In the case of FIG. 5, based on the belief that PDCCH corresponding to the False Alarm is not clear, the reception unit 13 may also be configured to decide neither to perform the reception of a downlink data signal based on the downlink control signal transmitted through the PDCCH #B, nor the reception of a downlink data signal based on the downlink control signal transmitted through the PDCCH #A.

In the case of FIG. 5, as a consequence, it is possible to perform the reception of a downlink data signal more reliably according to an instruction of the radio base station eNB, as compared with the operation in the case of FIG. 4.

In addition, as illustrated in FIG. 6, when “0” is set to information elements included in one of the plurality of downlink control signals, that is, “0” is set to the information element included in the downlink control signal transmitted through the PDCCH #B and “0” is set to the information element included in the downlink control signal transmitted through the PDCCH #A, the reception unit 13 may also be configured to decide to perform the reception of the downlink data using the first carrier in relation to the both downlink control signals transmitted through the PDCCH #A and the PDCCH #B.

In the case of FIG. 6, since a contradiction exists between the information element in the PDCCH #A and the information element in the PDCCH #B, it is assumed that one of the PDCCHs corresponds to the False Alarm.

Furthermore, in the case of FIG. 6, it is assumed that it is difficult to determine PDCCH corresponding to the False Alarm, differently from the case of FIG. 4.

In the case of FIG. 6, based on the belief that PDCCH corresponding to the False Alarm is not clear, the reception unit 13 may also be configured to decide neither to perform the reception of a downlink data signal based on the downlink control signal transmitted through the PDCCH #B, nor the reception of a downlink data signal based on the downlink control signal transmitted through the PDCCH #A.

In the case of FIG. 6, it is possible to perform the reception of a downlink data signal more reliably according to an instruction of the radio base station eNB.

In addition, in the above-mentioned example, it is decided whether to perform the reception of downlink data using a plurality of carriers, that is, perform the multicarrier reception, based on the 1-bit information element indicating whether the multicarrier reception is performed. Instead, bits indicating the presence or absence of the transmission of each carrier other than an own carrier may be defined, and it may be configured to decide whether to perform the reception of the downlink data using the plurality of carriers, that is, perform the multicarrier reception, based on the bits.

In this case, when no contradiction exists between the bits indicating the presence or absence of the transmission of each carrier other than the own carrier, the reception unit 13 may also be configured to decide to perform the reception of the downlink data based on the downlink control signal.

In other words, when a contradiction exists between the bits indicating the presence or absence of the transmission of each carrier other than the own carrier, the reception unit 13 may also be configured to decide not to perform the reception of the downlink data based on the downlink control signal.

For example, the following is an example of the case in which the first carrier and the second carrier exist.

Here, it is assumed that the downlink control signal transmitted through the PDCCH #A notifies the transmission of a downlink signal using the first carrier, and the downlink control signal transmitted through the PDCCH #B notifies the transmission of a downlink signal using the second carrier.

Furthermore, it is assumed that a bit indicating the transmission of the second carrier is defined in the PDCCH #A and a bit indicating the transmission of the first carrier is defined in the PDCCH #B.

Here, when the bit is “1”, it means that the transmission of a corresponding carrier is performed. When the bit is “0”, it means that the transmission of the corresponding carrier is not performed.

For example, as illustrated in FIG. 7, a case may be considered: in the information element included in a plurality of downlink control signals, i.e., the downlink control signal transmitted through the PDCCH #A, “1” is set in relation to the transmission of the second carrier, and in the information element included in the downlink control signal transmitted through the PDCCH #B, “1” is set in relation to the transmission of the first carrier.

In the case of FIG. 7, since no contradiction exists between the information element included in the downlink control signal transmitted through the PDCCH #A and the information element included in the downlink control signal transmitted through the PDCCH #B, the reception unit 13 may also be configured to decide to perform the reception (multicarrier reception) of the uplink data using the plurality of carriers, that is, the first carrier and the second carrier, based on the downlink control signals transmitted through the PDCCH #A and the PDCCH #B.

Furthermore, for example, as illustrated in FIG. 8, a case may be considered: in the information element included in a plurality of downlink control signals, i.e., the downlink control signal transmitted through the PDCCH #A, “0” is set in relation to the transmission of the second carrier, and in the information element included in the downlink control signal transmitted through the PDCCH #B, “1” is set in relation to the transmission of the first carrier.

In the case of FIG. 8, since a contradiction exists between the information element included in the downlink control signal transmitted through the PDCCH #A and the information element included in the downlink control signal transmitted through the PDCCH #B, the reception unit 13 may also be configured to decide neither to perform the reception of a downlink data signal of the second carrier based on the downlink control signal transmitted through the PDCCH #B, nor the reception of a downlink data signal of the first carrier based on the downlink control signal transmitted through the PDCCH #A.

Furthermore, for example, as illustrated in FIG. 9, a case may be considered: in the information element included in a plurality of downlink control signals, i.e., the downlink control signal transmitted through the PDCCH #A, “0” is set in relation to the transmission of the second carrier, and in the information element included in the downlink control signal transmitted through the PDCCH #B, “0” is set in relation to the transmission of the first carrier.

In the case of FIG. 9, since a contradiction exists between the information element included in the downlink control signal transmitted through the PDCCH #A and the information element included in the downlink control signal transmitted through the PDCCH #B, the reception unit 13 may also be configured to decide neither to perform the reception of a downlink data signal of the second carrier based on the downlink control signal transmitted through the PDCCH #B, nor the reception of a downlink data signal of the first carrier based on the downlink control signal transmitted through the PDCCH #A.

Next, the following is an example of the case in which the first carrier, the second carrier, and the third carrier exist.

Here, it is assumed that the downlink control signal transmitted through the PDCCH #A notifies the transmission of a downlink signal using the first carrier, the downlink control signal transmitted through the PDCCH #B notifies the transmission of a downlink signal using the second carrier, and a downlink control signal transmitted through PDCCH #C instructs the notification of a downlink signal using the third carrier.

Furthermore, it is assumed that a bit indicating the transmission of the second carrier and a bit indicating the transmission of the third carrier have been defined in the PDCCH #A, a bit indicating the transmission of the first carrier and the bit indicating the transmission of the third carrier have been defined in the PDCCH #B, and the bit indicating the transmission of the first carrier and the bit indicating the transmission of the second carrier have been defined in the PDCCH #C.

Here, when the bit is “1”, it means that the transmission of a corresponding carrier is performed. When the bit is “0”, it means that the transmission of the corresponding carrier is not performed.

For example, as illustrated in FIG. 10, a case may be considered in which among a plurality of downlink control signals, “1” is set to the information element included in the downlink control signal transmitted through the PDCCH #A in relation to the transmission of the second carrier and the transmission of the third carrier, “1” is set to the information element included in the downlink control signal transmitted through the PDCCH #B in relation to the transmission of the first carrier and the transmission of the third carrier, and “1” is set to the information element included in the downlink control signal transmitted through the PDCCH #C in relation to the transmission of the first carrier and the transmission of the second carrier.

In the case of FIG. 10, since no contradiction exists among the information element included in the downlink control signal transmitted through the PDCCH #A, the information element included in the downlink control signal transmitted through the PDCCH #B, and the information element included in the downlink control signal transmitted through the PDCCH #C, the reception unit 13 may also be configured to decide to perform the reception (multicarrier reception) of the downlink data using the plurality of carriers, that is, the first carrier, the second carrier, and the third carrier, based on the downlink control signals transmitted through the PDCCH #A, the PDCCH #B, and the PDCCH #C.

Here, for example, when “0” is set in relation to carriers other than an own carrier, with respect to at least one of the PDCCH #A, the PDCCH #B, and the PDCCH #C, a contradiction exists thereamong, and therefore, the reception unit 13 may also be configured to decide not to perform the reception (multicarrier reception) of the downlink data in relation to all of the first carrier, the second carrier, and the third carrier.

For example, as illustrated in FIG. 11, a case may be considered: in the information element included in a plurality of downlink control signals, i.e., the downlink control signal transmitted through the PDCCH #A, “0” is set in relation to the transmission of the second carrier and “1” is set in relation to the transmission of the third carrier, the PDCCH #B does not exist, in the information element included in the downlink control signal transmitted through the PDCCH #C, “1” is set in relation to the transmission of the first carrier and “0” is set in relation to the transmission of the second carrier.

In the case of FIG. 11, since no contradiction exists among the information element included in the downlink control signal transmitted through the PDCCH #A, the absence of the PDCCH #B, and the information element included in the downlink control signal transmitted through the PDCCH #C, the reception unit 13 may also be configured to decide to perform the reception (multicarrier reception) of the downlink data using the plurality of carriers, that is, the first carrier and the third carrier, based on the downlink control signals transmitted through the PDCCH #A and the PDCCH #C.

Here, for example, when the information elements in the PDCCH #A and the PDCCH #C have the values of FIG. 11 and the PDCCH #B exists, since a contradiction exists therebetween, the reception unit 13 may also be configured to decide not to perform the reception (multicarrier reception) of the downlink data in relation to all of the first carrier, the second carrier, and the third carrier.

Alternatively, for example, when a contradiction exists between an information element related to the presence or absence of the transmission of the third carrier in the PDCCH #A and an information element related to the presence or absence of the transmission of the first carrier in the PDCCH #C, the reception unit 13 may also be configured to decide not to perform the reception (multicarrier reception) of the downlink data in relation to all of the first carrier, the second carrier, and the third carrier.

For example, as illustrated in FIG. 12, a case may be considered: in the information element included in a plurality of downlink control signals, i.e., the downlink control signal transmitted through the PDCCH #A, “0” is set in relation to the transmission of the second carrier, “0” is set in relation to the transmission of the third carrier, and the PDCCH #B and the PDCCH #C do not exist.

In the case of FIG. 12, since no contradiction exists between the information element included in the downlink control signal transmitted through the PDCCH #A and the absence of the PDCCH #B and the PDCCH #C, the reception unit 13 may also be configured to decide to perform the reception (single carrier reception) of the downlink data using the single carrier, that is, the first carrier, based on the downlink control signal transmitted through the PDCCH #A.

Here, for example, when the information element in the PDCCH #A has the value of FIG. 12 and the PDCCH #B and the PDCCH #C exist, since a contradiction exists therebetween, the reception unit 13 may also be configured to decide not to perform the reception (multicarrier reception) of the downlink data in relation to all of the first carrier, the second carrier, and the third carrier.

In addition, in the above-mentioned example, in relation to carriers other than an own carrier, bits indicating the presence or absence of the transmission of the carriers have been defined. Instead, in relation to carriers including the own carrier, bits indicating the presence or absence of the transmission of the carriers may be defined.

In this case, in addition to the above-mentioned determination, when a bit indicating the presence or absence of the transmission of the own carrier is “0”, it may be determined that a contradiction exists. When the bit indicating the presence or absence of the transmission of the own carrier is “1”, it may be determined that no contradiction exists.

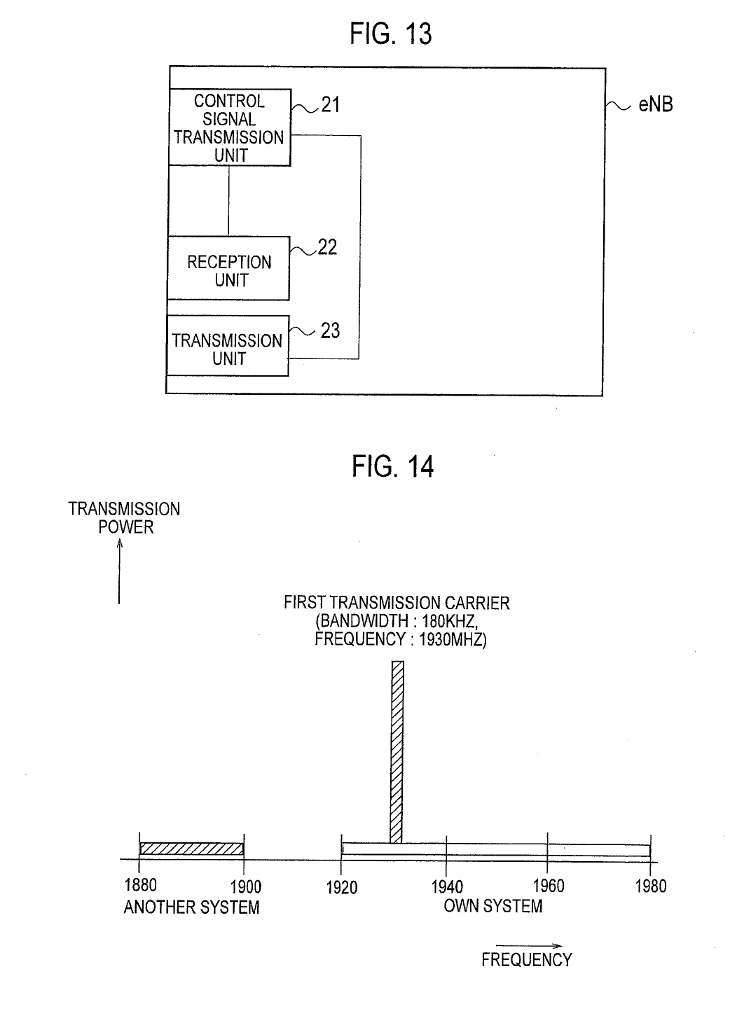

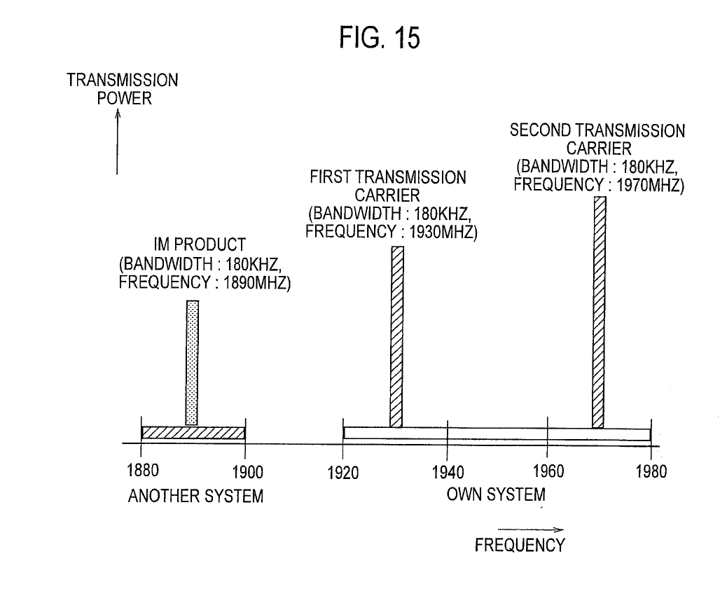

As illustrated in FIG. 13, the radio base station eNB includes a control signal transmission unit 21, a reception unit 22, and a transmission unit 23.

The control signal transmission unit 21 is configured to transmit one or a plurality of downlink control signals for instructing the transmission of uplink data (specifically, uplink data to be transmitted through the PUSCH), or for notifying the transmission of downlink data (specifically, downlink data to be transmitted through the PDSCH).

Specifically, the control signal transmission unit 21 may be configured to transmit an “uplink scheduling grant” or “downlink scheduling information” through the PDCCH as the downlink control signal.

The reception unit 22 is configured to receive uplink data transmitted by the mobile station UE using a plurality of carriers based on one or plurality of the downlink control signals.

The transmission unit 23 is configured to transmit downlink data to the mobile station UE using one of a plurality of carriers designated by the plurality of downlink control signals.

Here, the following two patterns are assumed as a case in which it is probable that the IM products occur by the uplink data transmitted by the mobile station UE.

A pattern 1 corresponds to a case in which the “False Alarm” occurs in both the PDCCH #A and the PDCCH #B, and the mobile station UE transmits the uplink data using the first carrier and the second carrier based on the “False Alarm”.

Furthermore, a pattern 2 corresponds to a case in which the “False Alarm” occurs in the PDCCH #B, and the mobile station UE transmits the uplink data using the second carrier based on the “False Alarm” and transmits the uplink data using the first carrier based on a regular downlink control signal (“0” is set to the information element) received through the PDCCH #A.

In accordance with the mobile communication system according to the first embodiment of the present invention, in the pattern 1, only when “1” is set to the both information elements included in the downlink control signals transmitted through the PDCCHs #A and #B, since it is probable that the “False Alarm” occurs, the occurrence probability of the “False Alarm” is considerably reduced to “1/(2¹⁶×2¹⁶)×1/4×40”, resulting in a considerable reduction of the occurrence probability of the IM products.

Furthermore, in accordance with the mobile communication system according to the first embodiment of the present invention, in the pattern 2, if a reception error rate of the downlink control signal transmitted through the PDCCH #A is set to 1%, the following effects are obtained.

When the mobile station UE has succeeded in receiving the downlink control signal through the PDCCH #A with a probability of 99%, since “0” is set to the information element included in the downlink control signal in the examples illustrated in FIG. 3 to FIG. 6, there is no problem even when the “False Alarm” occurs in the PDCCH #B.

Furthermore, even the mobile station UE has failed in receiving the downlink control signal through the PDCCH #A with a probability of 1%, since only CRC check is “NG”, the “False Alarm” does not occur in the PDCCH #A.

Consequently, in accordance with the mobile communication system according to the first embodiment of the present invention, in the pattern 2, the IM products do not occur.

The characteristics of the present embodiment as described above may be expressed as follows.

A first characteristic of the present embodiment is summarized in that a mobile communication method, in which a mobile station UE transmits uplink data to a radio base station eNB using a plurality of carriers, includes: a step A of instructing the mobile station UE to perform the transmission of uplink data using a plurality of downlink control signals including an information element for notifying the presence or absence of the transmission of uplink data using a plurality of carriers in a predetermined time frame; and a step B of deciding whether to perform the transmission of the uplink data using the plurality of carriers based on the information element included in the plurality of received downlink control signals.

In the first characteristic of the present embodiment, in the step B, only when the information element included in the plurality of downlink control signals indicates that the transmission of the uplink data using the plurality of carriers exists, it may be decided to perform the transmission of the uplink data using the plurality of carriers based on the plurality of downlink control signals.

In the first characteristic of the present embodiment, in the step B, when the information element included in one of the plurality of downlink control signals indicates that the transmission of the uplink data using the plurality of carriers does not exist, it may be decided to perform the transmission of the uplink data based on the downlink control signal including the information element indicating that the transmission of the uplink data using the plurality of carriers does not exist.

In the first characteristic of the present embodiment, in the step B, when the information element included in at least one of the plurality of downlink control signals indicates that the transmission of the uplink data using the plurality of carriers does not exist, it may be decided not to perform the transmission of the uplink data in relation to all the plurality of downlink control signals.

In the first characteristic of the present embodiment, in the step B, when the information element included in two or more of the plurality of downlink control signals indicates that the transmission of the uplink data using the plurality of carriers does not exist, it may be decided not to perform the transmission of the uplink data in relation to all the plurality of downlink control signals.

A second characteristic of the present embodiment is summarized in that a mobile station UE, which is configured to transmit uplink data to a radio base station eNB using a plurality of carriers, includes: a control signal reception unit 11 configured to receive a plurality of downlink control signals from the radio base station eNB, which include an information element for notifying the presence or absence of the transmission of uplink data using a plurality of carriers in a predetermined time frame; and a transmission unit 12 configured to decide whether to perform the transmission of the uplink data using the plurality of carriers based on the information element included in the plurality of received downlink control signals.

In the second characteristic of the present embodiment, only when the information element included in the plurality of downlink control signals indicates that the transmission of the uplink data using the plurality of carriers exists, the transmission unit 12 may be configured to decide to perform the transmission of the uplink data using the plurality of carriers based on the plurality of downlink control signals.

In the second characteristic of the present embodiment, when the information element included in one of the plurality of downlink control signals indicates that the transmission of the uplink data using the plurality of carriers does not exist, the transmission unit 12 may be configured to decide to perform the transmission of the uplink data based on the downlink control signal including the information element indicating that the transmission of the uplink data using the plurality of carriers does not exist.

In the second characteristic of the present embodiment, when the information element included in at least one of the plurality of downlink control signals indicates that the transmission of the uplink data using the plurality of carriers does not exist, the transmission unit 12 may be configured to decide not to perform the transmission of the uplink data in relation to all the plurality of downlink control signals.

In the second characteristic of the present embodiment, when the information element included in two or more of the plurality of downlink control signals indicates that the transmission of the uplink data using the plurality of carriers does not exist, the transmission unit 12 may be configured to decide not to perform the transmission of the uplink data in relation to all the plurality of downlink control signals.

A third characteristic of the present embodiment is summarized in that a radio base station eNB, which is configured to receive uplink data from a mobile station UE using a plurality of carriers, includes: a control signal transmission unit 21 configured to transmit a plurality of downlink control signals to the mobile station UE, which include an information element for notifying the presence or absence of the transmission of uplink data using a plurality of carriers in a predetermined time frame and instruct the transmission of the uplink data using the plurality of carriers; and a reception unit 22 configured to receive the uplink data transmitted by the mobile station UE using the plurality of carriers based on the plurality of downlink control signals.

In the third characteristic of the present embodiment, the control signal transmission unit may be configured to set the information element to indicate that the transmission of the uplink data using the plurality of carriers exists when the radio base station eNB instructs the mobile station to perform the transmission of the uplink data using the plurality of carriers, and configured to set the information element to indicate that the transmission of the uplink data using the plurality of carriers does not exist when the radio base station eNB instructs the mobile station to perform the transmission of the uplink data using one carrier.

A fourth characteristic of the present embodiment is summarized in that a mobile communication method, in which a radio base station eNB transmits downlink data to a mobile station UE using a plurality of carriers, includes: a step A of instructing the mobile station UE to perform the reception of downlink data using a plurality of downlink control signals including an information element for notifying the presence or absence of the transmission of downlink data using a plurality of carriers in a predetermined time frame; and a step B of deciding whether to perform the reception of the downlink data using the plurality of carriers based on the information element included in the plurality of received downlink control signals.

In the fourth characteristic of the present embodiment, in the step B, only when the information element included in the plurality of downlink control signals indicates that the transmission of the downlink data using the plurality of carriers exists, it may be decided to perform the reception of the downlink data using the plurality of carriers based on the plurality of downlink control signals.

In the fourth characteristic of the present embodiment, in the step B, when the information element included in one of the plurality of downlink control signals indicates that the transmission of the downlink data using the plurality of carriers does not exist, it may be decided to perform the reception of the downlink data based on the downlink control signal including the information element indicating that the transmission of the downlink data using the plurality of carriers does not exist.

In the fourth characteristic of the present embodiment, in the step B, when the information element included in at least one of the plurality of downlink control signals indicates that the transmission of the downlink data using the plurality of carriers does not exist, it may be decided not to perform the reception of the downlink data in relation to all the plurality of downlink control signals.

In the fourth characteristic of the present embodiment, in the step B, when the information element included in two or more of the plurality of downlink control signals indicates that the transmission of the downlink data using the plurality of carriers does not exist, it may be decided not to perform the reception of the downlink data in relation to all the plurality of downlink control signals.

A fifth characteristic of the present embodiment is summarized in that a mobile station UE, which is configured to receive downlink data from a radio base station eNB using a plurality of carriers, includes: a control signal reception unit 11 configured to receive a plurality of downlink control signals from the radio base station eNB, which include an information element for notifying the presence or absence of the transmission of downlink data using a plurality of carriers in a predetermined time frame; and a reception unit 13 configured to decide whether to perform the reception of the downlink data using the plurality of carriers based on the information element included in the plurality of received downlink control signals.

In the fifth characteristic of the present embodiment, only when the information element included in the plurality of downlink control signals indicates that the transmission of the downlink data using the plurality of carriers exists, the reception unit 13 may be configured to decide to perform the reception of the downlink data using the plurality of carriers based on the plurality of downlink control signals.

In the fifth characteristic of the present embodiment, when the information element included in one of the plurality of downlink control signals indicates that the transmission of the downlink data using the plurality of carriers does not exist, the reception unit 13 may be configured to decide to perform the reception of the downlink data based on the downlink control signal including the information element indicating that the transmission of the downlink data using the plurality of carriers does not exist.

In the fifth characteristic of the present embodiment, when the information element included in at least one of the plurality of downlink control signals indicates that the transmission of the downlink data using the plurality of carriers does not exist, the reception unit 13 may be configured to decide not to perform the reception of the downlink data in relation to all the plurality of downlink control signals.

In the fifth characteristic of the present embodiment, when the information element included in two or more of the plurality of downlink control signals indicates that the transmission of the downlink data using the plurality of carriers does not exist, the reception unit 13 may be configured to decide not to perform the reception of the downlink data based on all the plurality of downlink control signals.

A sixth characteristic of the present embodiment is summarized in that a radio base station eNB, which is configured to transmit downlink data to a mobile station UE using a plurality of carriers, includes: a control signal transmission unit 21 configured to transmit a plurality of downlink control signals to the mobile station UE, which include an information element for notifying the presence or absence of the transmission of downlink data using a plurality of carriers in a predetermined time frame and instruct the reception of the downlink data using the plurality of carriers; and a transmission unit 23 configured to transmit the downlink data to the mobile station UE using the plurality of carriers designated by the plurality of downlink control signals.

In the sixth characteristic of the present embodiment, the control signal transmission unit may be configured to set the information element to indicate that the transmission of the downlink data using the plurality of carriers exists when the radio base station eNB notifies the mobile station of the transmission of the downlink data using the plurality of carriers, and configured to set the information element to indicate that the transmission of the downlink data using the plurality of carriers does not exist when the radio base station eNB notifies the mobile station of the transmission of the downlink data using one of the plurality of carriers.

In addition, the operation of the above-mentioned the radio base station eNB or the mobile station UE may be implemented by hardware, may also be implemented by a software module executed by a processor, or may further be implemented by the combination of the both.

The software module may be arranged in a storage medium of an arbitrary format such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

Such a storage medium is connected to the processor so that the processor can write and read information into and from the storage medium. Such a storage medium may also be accumulated in the processor. Such storage medium and processor may be arranged in an ASIC. Such ASIC may be arranged in the radio base station eNB or the mobile station UE. As a discrete component, such storage medium and processor may be arranged in the radio base station eNB or the mobile station UE.

Thus, the present invention has been specifically explained by using the above-mentioned embodiments; however, it is obvious that for persons skilled in the art, the present invention is not limited to the embodiments explained herein. The present invention can be implemented as corrected and modified modes without departing from the gist and the scope of the present invention defined by the claims. Therefore, the description of the specification is intended for explaining the example only and does not impose any limited meaning to the present invention.

### INDUSTRIAL APPLICABILITY

As described above, in accordance with the present invention, it is possible to provide a mobile communication method, a mobile station, and a radio base station, by which it is possible to reduce interference to another system and realize the coexistence with the other system by reducing the probability of False Alarm in multicarrier transmission.

1. A mobile communication method, in which a mobile station transmits uplink data to a radio base station using a plurality of carriers, comprising:
a step A of instructing the mobile station to perform transmission of uplink data using a plurality of downlink control signals including an information element for notifying presence or absence of transmission of the uplink data using a plurality of carriers in a predetermined time frame; and
a step B of deciding whether to perform the transmission of the uplink data using the plurality of carriers based on the information element included in the plurality of received downlink control signals.

2. The mobile communication method according to claim 1, wherein,
in the step B, only when the information element included in the plurality of downlink control signals indicates that the transmission of the uplink data using the plurality of carriers exists, it is decided to perform the transmission of the uplink data using the plurality of carriers based on the plurality of downlink control signals.

3. The mobile communication method according to claim 1, wherein,
in the step B, when the information element included in one of the plurality of downlink control signals indicates that the transmission of the uplink data using the plurality of carriers does not exist, it is decided to perform the transmission of the uplink data based on the downlink control signal including the information element indicating that the transmission of the uplink data using the plurality of carriers does not exist.

4. The mobile communication method according to claim 1, wherein,
in the step B, when the information element included in at least one of the plurality of downlink control signals indicates that the transmission of the uplink data using the plurality of carriers does not exist, it is decided not to perform the transmission of the uplink data in relation to all the plurality of downlink control signals.

5. The mobile communication method according to claim 1, wherein,
in the step B, when the information element included in two or more of the plurality of downlink control signals indicates that the transmission of the uplink data using the plurality of carriers does not exist, it is decided not to perform the transmission of the uplink data in relation to all the plurality of downlink control signals.

6. A mobile station, which is configured to transmit uplink data to a radio base station using a plurality of carriers, comprising:
a control signal reception unit configured to receive a plurality of downlink control signals from the radio base station, the plurality of downlink control signals including an information element for notifying presence or absence of transmission of uplink data using a plurality of carriers in a predetermined time frame; and
a transmission unit configured to decide whether to perform the transmission of the uplink data using the plurality of carriers based on the information element included in the plurality of received downlink control signals.

7. The mobile station according to claim 6, wherein
only when the information element included in the plurality of downlink control signals indicates that the transmission of the uplink data using the plurality of carriers exists, the transmission unit is configured to decide to perform the transmission of the uplink data using the plurality of carriers based on the plurality of downlink control signals.

8. The mobile station according to claim 6, wherein
when the information element included in one of the plurality of downlink control signals indicates that the transmission of the uplink data using the plurality of carriers does not exist, the transmission unit is configured to decide to perform the transmission of the uplink data based on the downlink control signal including the information element indicating that the transmission of the uplink data using the plurality of carriers does not exist.

9. The mobile station according to claim 6, wherein
when the information element included in at least one of the plurality of downlink control signals indicates that the transmission of the uplink data using the plurality of carriers does not exist, the transmission unit is configured to decide not to perform the transmission of the uplink data in relation to all the plurality of downlink control signals.

10. The mobile station according to claim 6, wherein
when the information element included in two or more of the plurality of downlink control signals indicates that the transmission of the uplink data using the plurality of carriers does not exist, the transmission unit is configured to decide not to perform the transmission of the uplink data in relation to all the plurality of downlink control signals.

11. A radio base station, which is configured to receive uplink data from a mobile station using a plurality of carriers, comprising:
a control signal transmission unit configured to transmit a plurality of downlink control signals to the mobile station, the plurality of downlink control signals including an information element for notifying presence or absence of transmission of uplink data using a plurality of carriers in a predetermined time frame and instructing the transmission of the uplink data using the plurality of carriers; and
a reception unit configured to receive the uplink data transmitted by the mobile station using the plurality of carriers based on the plurality of downlink control signals.

12. The radio base station according to claim 11, wherein
the control signal transmission unit is configured to set the information element to indicate that the transmission of the uplink data using the plurality of carriers exists when the radio base station instructs the mobile station to perform the transmission of the uplink data using the plurality of carriers, and
configured to set the information element to indicate that the transmission of the uplink data using the plurality of carriers does not exist when the radio base station instructs the mobile station to perform the transmission of the uplink data using one carrier.

13. A mobile communication method, in which a radio base station transmits downlink data to a mobile station using a plurality of carriers, comprising:
a step A of instructing the mobile station to perform reception of downlink data using a plurality of downlink control signals including an information element for notifying presence or absence of transmission of downlink data using a plurality of carriers in a predetermined time frame; and
a step B of deciding whether to perform the reception of the downlink data using the plurality of carriers based on the information element included in the plurality of received downlink control signals.

14. The mobile communication method according to claim 13, wherein
in the step B, only when the information element included in the plurality of downlink control signals indicates that the transmission of the downlink data using the plurality of carriers exists, it is decided to perform the reception of the downlink data using the plurality of carriers based on the plurality of downlink control signals.

15. The mobile communication method according to claim 13, wherein
in the step B, when the information element included in one of the plurality of downlink control signals indicates that the transmission of the downlink data using the plurality of carriers does not exist, it is decided to perform the reception of the downlink data based on the downlink control signal including the information element indicating that the transmission of the downlink data using the plurality of carriers does not exist.

16. The mobile communication method according to claim 13, wherein
in the step B, when the information element included in at least one of the plurality of downlink control signals indicates that the transmission of the downlink data using the plurality of carriers does not exist, it is decided not to perform the reception of the downlink data in relation to all the plurality of downlink control signals.

17. The mobile communication method according to claim 13, wherein
in the step B, when the information element included in two or more of the plurality of downlink control signals indicates that the transmission of the downlink data using the plurality of carriers does not exist, it is decided not to perform the reception of the downlink data in relation to all the plurality of downlink control signals.

18. A mobile station, which is configured to receive downlink data from a radio base station using a plurality of carriers, comprising:
a control signal reception unit configured to receive a plurality of downlink control signals from the radio base station, the plurality of downlink control signals including an information element for notifying presence or absence of transmission of downlink data using a plurality of carriers in a predetermined time frame; and
a reception unit configured to decide whether to perform the reception of the downlink data using the plurality of carriers based on the information element included in the plurality of received downlink control signals.

19. The mobile station according to claim 18, wherein
only when the information element included in the plurality of downlink control signals indicates that the transmission of the downlink data using the plurality of carriers exists, the reception unit is configured to decide to perform the reception of the downlink data using the plurality of carriers based on the plurality of downlink control signals.

20. The mobile station according to claim 18, wherein
when the information element included in one of the plurality of downlink control signals indicates that the transmission of the downlink data using the plurality of carriers does not exist, the reception unit is configured to decide to perform the reception of the downlink data based on the downlink control signal including the information element indicating that the transmission of the downlink data using the plurality of carriers does not exist.

21. The mobile station according to claim 18, wherein
when the information element included in at least one of the plurality of downlink control signals indicates that the transmission of the downlink data using the plurality of carriers does not exist, the reception unit is configured to decide not to perform the reception of the downlink data in relation to all the plurality of downlink control signals.

22. The mobile station according to claim 18, wherein
when the information element included in two or more of the plurality of downlink control signals indicates that the transmission of the downlink data using the plurality of carriers does not exist, the reception unit is configured to decide not to perform the reception of the downlink data in relation to all the plurality of downlink control signals.

23. A radio base station, which is configured to transmit downlink data to a mobile station using a plurality of carriers, comprising:
a control signal transmission unit configured to transmit a plurality of downlink control signals to the mobile station, the plurality of downlink control signals including an information element for notifying presence or absence of transmission of downlink data using a plurality of carriers in a predetermined time frame and instructing reception of the downlink data using the plurality of carriers; and
a transmission unit configured to transmit the downlink data to the mobile station using the plurality of carriers designated by the plurality of downlink control signals.

24. The radio base station according to claim 23, wherein
the control signal transmission unit is configured to set the information element to indicate that the transmission of the downlink data using the plurality of carriers exists when the radio base station notifies the mobile station of the transmission of the downlink data using the plurality of carriers, and
the control signal transmission unit is configured to set the information element to indicate that the transmission of the downlink data using the plurality of carriers does not exist when the radio base station notifies the mobile station of the transmission of the downlink data using one of the plurality of carriers.
